(19) United States
(12) Patent Application Publication
(10) Pub. No.: US 2008/0223847 A1
(43) Pub. Date: Sep. 18, 2008

(54) ELECTRIC GRILL AND METHOD OF USING SAME

(76) Inventor: Po-Chun Kuo, Tainan Hsien (TW)

Correspondence Address: GREER, BURNS & CRAIN, 300 S WACKER DR, 25TH FLOOR, CHICAGO, IL, 60606, US

(21) Appl. No.: 12/048,860

(22) Filed: Mar. 14, 2008

(30) Foreign Application Priority Data
Mar. 16, 2007 (CN) 200710008711.3

(51) Int. Cl. H05B 3/02; H05B 3/06; F24C 7/10; H05B 1/02

(52) U.S. Cl. 219/489; 219/521; 219/494; 219/386

(57) ABSTRACT

An electric grill includes at least one grill pan having a first heating member, a second heating member, and a temperature sensing member for measuring the temperature of the grill pan; and the first heating member, the second heating member and the temperature sensing member connect with a control circuit. The temperature sensing member provides a temperature signal for the control circuit, and the control circuit controls the power on/off of the first heating member and the second heating member.

### BACKGROUND OF THE INVENTION

1. Field of the Invention

The present invention relates to grill, and more particularly relates to an electric grill and method of using same.

2. Related Art

Generally, grills have two following heating-up methods in prior arts: one is heated up by an electric heating tube, and the other is heated by gas. The characteristic of the grills heated by gas is having a rapid heating-up rate, but it is not easy to control the temperature of grill; the characteristic of the grill heated by the electric heating tube is having a slow heating-up rate, but it is easy to control the temperature of grill. High-grade steak needs a little brown surface, hot and juicy inside, which demands that the grill pan can reach a high temperature rapidly by strong fire when frying the steaks. But existing electric grill can not meet the demand.

### SUMMARY OF THE INVENTION

The present invention provides an electric grill and method of using same, the primary object of the present invention is to obviate the disadvantage of existing electric grills having slowly-rise temperature and being hard to cook brown-outside and tender-inside flesh food.

Such object of the present invention will become apparent in the ensuing description:

An electric grill is provided in the present invention. The electric grill comprises at least a grill pan comprising a first heating member, a second heating member, and a temperature sensing member for measuring the temperature of the grill pan, wherein the first heating member, the second heating member and the temperature sensing member connect with a control circuit. The temperature sensing member provides a temperature signal for the control circuit, and the control circuit controls the power on/off of the first heating member and the second heating member. A switch controlling the power-on/off of the second heating member is provided in the electric grill, and the switch connects with the control circuit. The grill pan will be heated up to a temperature between 250˜300° C. when the second heating member is electrified. The second heating member can heat the grill pan at least more than 1 minute when it is electrified. A temperature control knob controlling the power on/off of the first heating member is provided in the electric grill. The temperature control knob connects with the control circuit, which comprising a control chip and a power board. The power board includes a rectifier for providing power supply to the control chip, a first relay with output-terminal connecting the power supply circuit of the first heating member, a second relay with output-terminal connecting the power supply circuit of the second heating member, and the control terminals of the first relay and second relay connect with the control chip. According to one embodiment of the present invention, the first heating member and the second heating member are electric heating tubes embedded in the backside of the grill pan.

According to one embodiment of the present invention, the first heating member and second heating member are C-shape.

According to one embodiment of the present invention, the first heating member surrounds the outside of the second heating member.

According to one embodiment of the present invention, the temperature sensing member is a thermistor which is adhered to the back surface of the grill pan, and its signal output terminal connects with the control chip.

According to one embodiment of the present invention, further comprising a display member which connects with the control circuit.

To achieve the aforementioned object, the present invention provides one method of using the grill. The method comprises the steps of providing an electric grill comprising a first heating member, a second heating member for heating up the grill pan, and a temperature sensing member for measuring the temperature of grill pan, wherein the first heating member, the second heating member and the temperature sensing member connect with a control circuit, and the temperature sensing member provides a temperature signal to the control circuit, which controls the power on/off of the first heating member and the second heating member; inputting a first signal to the control circuit controlling the electrification of the first heating member, wherein the temperature of the grill pan will reach lower than 250° C.; and inputting a second signal to the control circuit controlling the electrification of the second heating member, herein the temperature of the grill pan can reach between 250° C.˜300° C.

In the method of using the grill of the present invention, the heating time of the grill pan heated by the second heating member is at least more than 1 minute.

To achieve the aforementioned object, the present invention provides another method of using the grill. The method comprises the steps of providing an electric grill comprising a first heating member, a second heating member for heating up the grill pan, and a temperature sensing member for measuring the temperature of grill pan, wherein the first heating member, the second heating member and the temperature sensing member connect with a control circuit, and the temperature sensing member provides a temperature signal to the control circuit, which controls the power on/off of the first heating member and the second heating member; inputting a first signal to the control circuit controlling the electrification of the first heating member, wherein the temperature of the grill pan will reach lower than 250° C.; and inputting a second signal to the control circuit controlling the electrification of the second heating member, wherein the temperature of the grill pan can reach between 250° C.˜300° C.

In foregoing method, the heating time of the grill pan heated by the second heating member is at least more than 1 minute.

As shown in above-mentioned descriptions compared with the existing grills, the present invention has advantages as follows: the present grill has two heating members, so it can control the power on/off of the two heating members depending on the requirements of the food to be cooked, when the two heating members are electrified, the temperature of the grill pan will rise rapidly, therefore it can cook tender and juicy steak or the other likely flesh food by using the grill; while only one heating member is electrified, the grill can fry various food by adjusting the temperature like the other electric grills.

### BRIEF DESCRIPTION OF THE DRAWINGS

FIG. 1 is an exploded view of the present invention.

FIG. 2 is a schematic circuit diagram of the present invention.

FIG. 3 is a flow chart of frying food by using the grill provided in the present invention.

### DETAILED DESCRIPTION OF THE PREFERRED EMBODIMENTS

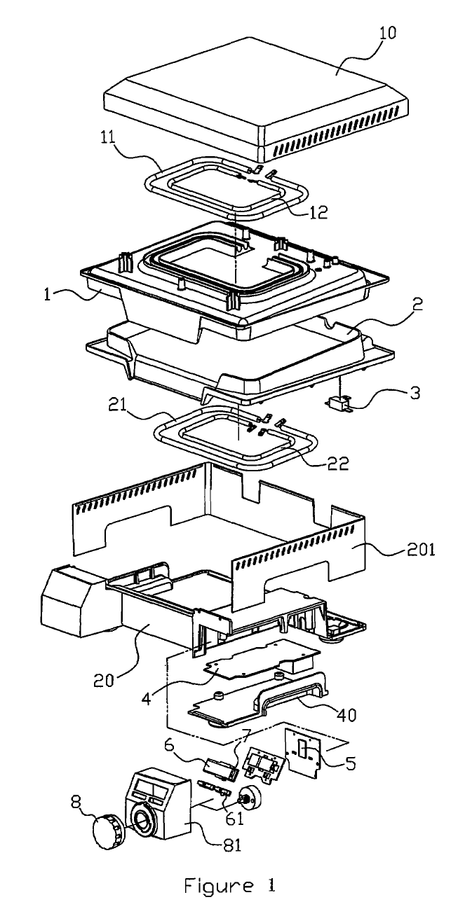

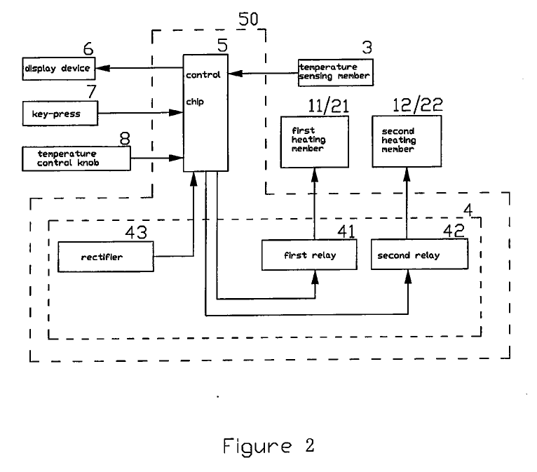

The present invention is to provide two heating members to the grill pan of the grill, to perform a better cooking effect by the cooperation of the two heating members, an exemplary electric grill according to a preferred embodiment of the present invention is shown in FIG. 1 and FIG. 2

Referring to FIG. 1, the grill includes an upper grill pan 1 and a lower grill pan 2, a cover 10 positioned over the top of the upper grill pan 1, a base 20 positioned below the bottom of the lower grill pan 2. The base 20 connects with the left, right, back sides of lower grill pan 2 through a shallow retaining wall 201, and a control panel is formed on the front side of the base 20. The right side of base 20 forms a fitting room for control and display components. The front side of fitting room is front platform 81, and a bottom side thereof is bottom plate 40. The connecting structure for the upper grill pan 1 and the lower grill pan 2 is a rotatable hinge-connecting structure, which is an existing technology and not shown in FIG. 1, it is inessential to the stress of the present invention and not detail described here.

Referring to FIG. 1, a first heating member 11 and a second heating member 12 are embedded in the backside of the upper grill pan 1, i.e. non-fry side, for heating up the upper grill pan 1, a first heating member 21 and a second heating member 22 are embedded in the backside of the lower grill pan 2, i.e. non-fry side, for heating up the lower grill pan 2 in the same way. The first heating members 11, 21 and second heating members 12, 22 are all C-shape electric heating tubes mounted in the backside of the upper grill pan 1 or the lower grill pan 2 respectively. And the first heating members 11, 21 surround the second heating members 12, 22 respectively. The first heating members 11, 21 are used for heating up the upper grill pan 1 and the lower grill pan 2 in a routine heating way, and their structures and heating ways are similar to common electric heating grill structures. However, the second heating members 12, 22 would heat the upper grill pan 1 and the lower grill pan 2 additionally besides the heating of the first heating members 11, 21, i.e. the second heating members 12, 22 and first heating members 11, 21 can heat the upper grill pan 1 and lower grill pan 2 at the same time to rise the pan's temperature rapidly.

Referring to FIG. 1, a temperature sensing member 3 is adhered to the backside of the lower grill pan 2, i.e. non-frying side. And referring to FIG. 2, the first heating members 11, 21, the second heating members 12, 22 and the temperature sensing member 3 connect with a control circuit 50. The temperature sensing member 3 provides a temperature signal to control circuit 50, and the control circuit 50 controls the power on/off of the first heating members 11, 21, the second heating members 12, 22 depending on the temperature of grill pan and the user choice by adjusting the switch knob.

Referring to FIG. 2, the control circuit 50 comprises a control chip 5 and a power board 4, and referring to FIG. 1 too, the power board 4 includes a rectifier 43 for providing power supply to the control chip 5, a first relay 41 whose output-terminal connects the power supply circuit of the first heating members 11, 21, a second relay 42 whose output-terminal connects the power supply circuit of the second heating members 12, 22, the control terminals of the first relay 41 and the second relay 42 connect with the control chip 5, and the power on/off is controlled by the control chip 5. The signal output terminal of the temperature sensing member 3 connects with the control chip 5.

Referring to FIG. 1, the power board 4 and the control chip 5 are mount in the fitting room of the base 20, and the front platform 81 has a display member 6, a switch 7 and a temperature control knob 8. The display member 6 is a LED display which is controlled by the control chip 5, showing information e.g. temperature of the grill pan. The switch 7 is used to control the second heating members 12, 22, i.e. the switch 7 is used in controlling the additional heat function on/off. The temperature control knob 8 is used in adjusting the temperature of the grill pan on common heat condition. The switch 7 and the temperature control knob 8 connect with the control chip 5 and provide control signals to it. It is worthy to note that the switch 7 can control the first heating members 11, 21 besides the control of the second heating members 12, 22 at the same time, i.e. signals from the switch 7 can control both the first heating members 11, 21 and the second heating members 12, 22 at the same time. The temperature control knob 8 can only control the first heating members 11, 21. The front base 81 has a key-press 61, the key-press 61 includes two key-press icons “+” and “−” for adjusting the heating time.

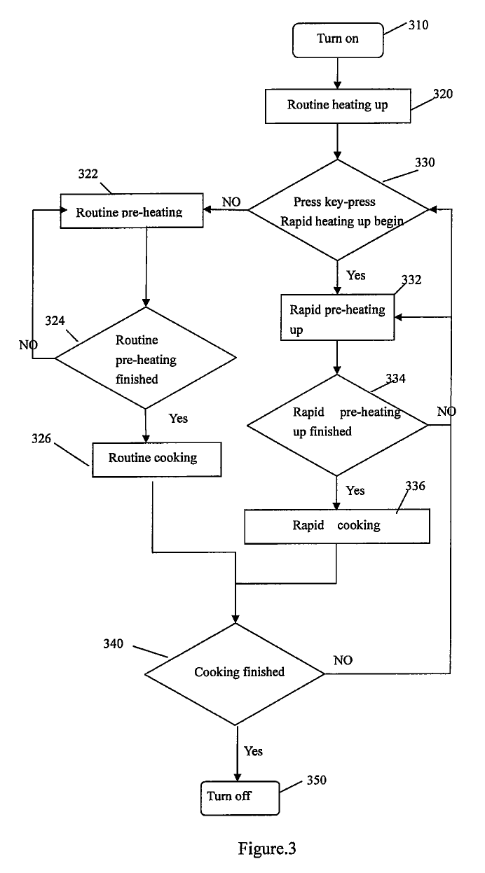

Referring to FIG. 3, it is a flow chart of frying food by using the grill provided in the present invention. Firstly, the grill is provided, and the power supply is turned on in step 310, then, the temperature control knob is adjusted to input a first signal to the control circuit, here the control circuit will control the first heating member to be electrified for performing a routine heating up step 320. If the user does not press the key-press of step 330, it will process a routine pre-heating step 322, a routine pre-heating finish step 324, and a routine cooking step 326 etc. in sequence. In this embodiment, the temperature of the routine cooking procedure will be below 250° C. Alternatively, if the key-press of step 330 is pressed, then it will input a second control signal to the control circuit, and the control circuit will electrify the second heating member to proceed a rapidly high temperature cooking function. This rapidly high temperature cooking program includes a rapid pre-heating up step 332, a rapid pre-heating up finish step 334 and a rapid cooking step 336.

In this embodiment, the temperature of grill pan will be between 250° C.˜300° C. in the rapid cooking step, heating time would be between 1-5 minutes. The food cooked in a short time on the high temperature will form a brown surface. Then the control circuit will break off the second heating member automatically to make the grill return to the state before pressing the key-press of step 330. After food cooking finished 340, the temperature knob is turned to input a third signal into the control circuit. Then the control circuit will break off the first heating member automatically. After that, the grill 350 is turned off. It is worthy to note that if the user does not want to use the function after pressing the key-press, it can repress the key-press to cancel. The other choice is to press the key-press after the power of the grill is turned on. When the control circuit receives the signal from the switch, the first and second heating members will be electrified for heating up. The temperature of the grill pan will be between 250° C.˜300° C., and the heating time will between 1-5 minutes for a rapidly high temperature cooking. Then the grill will return to the state before pressing the key-press.

The foregoing description of the exemplary embodiment of the invention has been presented for the purposes of illustration and description. It is not intended to be exhaustive or to limit the invention to the precise form disclosed. Many modifications and variations are possible in light of the above teaching. All changes that come within the meaning and range of equivalency of the claims are to be embraced within their scope

What is claimed is:

1. An electric grill, comprising:
at least a grill pan, a first heating member and a second heating member for heating said grill pan, a temperature sensing member for measuring the temperature of said grill pan; and a control circuit connected with said first heating member, said second heating member and said temperature sensing member, wherein said temperature sensing member provides a temperature signal to said control circuit, and said control circuit controls the power on/off of said first heating member and said second heating member.

2. The electric grill according to claim 1, further comprising a switch which controls the power-on/off of said second heating member, and said switch connects with said control circuit.

3. The electric grill according to claim 2, wherein said grill pan can be heated up to a temperature between 250˜300° C. when said second heating member is electrified to heat said grill pan.

4. The electric grill according to claim 3, wherein said second heating member can be electrified to heat said grill pan at least more than 1 minute.

5. The electric grill according to claim 4, further comprising a temperature control knob which controls the power on/off of said first heating member, and said temperature control knob connects with said control circuit.

6. The electric grill according to claim 5, wherein said control circuit comprises a control chip and a power board, and said power board comprises a rectifier for providing power supply to said control chip, a first relay with output-terminal connecting the power supply circuit of said first heating member, a second relay with output-terminal connecting the power supply circuit of said second heating member, and the control terminals of said first relay and said second relay connect with said control chip.

7. The electric grill according to claim 6, wherein said first heating member and said second heating member are electric heating tubes, whose shape are C-type, embedded in the backside of said grill pan, and said first heating member surrounds the outside of said second heating member.

8. The electric grill according to claim 6, wherein said temperature sensing member is a thermistor which is adhered to the back surface of said grill pan, and its signal output terminal connects with said control chip.

9. The electric grill according to claim 2, further comprising a display member which connects with said control circuit.

10. A method of using an electric grill, said method comprising the steps of:
providing an electric grill comprising a first heating member for heating a grill pan, a second heating member for heating said grill pan, and a temperature sensing member for measuring the temperature of said grill pan, wherein said first heating member, said second heating member and said temperature sensing member connect with a control circuit, and said temperature sensing member provides a temperature signal to said control circuit, which controls the power on/off of said first heating members and said second heating members;
inputting a first signal to said control circuit which controls the electrification of said first heating member, wherein the temperature of said grill pan heated by said first heating member will reach lower than 250° C.; and
inputting a second signal to said control circuit which controls the electrification of said second heating member, wherein the temperature of said grill pan heated by said second heating member will reach between 250° C.˜300° C.

11. The method of using the electric grill according to claim 10, wherein the heating time of said grill pan heated by said second heating member is at least more than 1 minute.

12. A method of using an electric grill, said method comprising the steps of:
providing an electric grill comprising a first heating member for heating a grill pan, a second heating member for heating said grill pan, and a temperature sensing member for measuring the temperature of said grill pan, wherein said first heating member, said second heating member and said temperature sensing member connect with a control circuit, and said temperature sensing member provides a temperature signal to said control circuit, which controls the power on/off of said first heating member and said second heating member; and
inputting a signal to said control circuit controlling the electrification of said first heating member and second heating member, wherein the temperature of said grill pan heated by said first heating member and second heating member will reach between 250° C.˜300° C.

13. The method of using the electric grill according to claim 12, wherein the heating time of said grill pan heated by said second heating member is at least more than 1 minute.
